(19) United States
(12) Patent Application Publication
(10) Pub. No.: US 2024/0347784 A1
(43) Pub. Date: Oct. 17, 2024

(54) HEAT ABSORPTION SEPARATORS FOR HIGH ENERGY BATTERIES

(71) Applicant: Celgard, LLC, Charlotte, NC (US)

(72) Inventors: Zhengming Zhang, Rock Hill, SC (US); Wenbin Yin, Charlotte, NC (US)

(21) Appl. No.: 18/683,798

(22) PCT Filed: Jun. 7, 2022
(86) PCT No.: PCT/US2022/032440

§ 371 Date: Feb. 15, 2024

Related U.S. Application Data
(60) Provisional application No. 63/235,483, filed on Aug. 20, 2021.

(51) Int. Cl. H01M 10/42; H01M 10/613; H01M 10/653; H01M 10/6551; H01M 50/417; H01M 50/434; H01M 50/457; H01M 50/491

(52) U.S. Cl. CPC H01M 10/4235; H01M 10/613; H01M 10/653; H01M 10/6551; H01M 50/417; H01M 50/434; H01M 50/457; H01M 50/491

(57) ABSTRACT

A battery separator is provided comprising a microporous membrane comprising one or more layers of a polyolefin and a heat absorption layer affixed to a surface of the microporous membrane, wherein the heat absorption layer is configured to absorb heat and reduce thermal propagation within a battery cell. The heat absorption layer can comprise at least one of a phase change material or a high heat capacity material configured to absorb heat in or above a normal battery cell operating range.

### RELATED APPLICATION DATA

The present application is a 371 application to PCT Application No. PCT/US2022/032440, filed Jun. 7, 2022, which claims priority to U.S. Provisional patent application Ser. No. 63/235,483 filed on Aug. 20, 2021, which is incorporated herein by reference in its entirety.

### FIELD

The technology described herein generally relates to separators, membranes, and/or thin films, and more particularly to systems thereof incorporating heat absorption features for high energy density batteries.

### BACKGROUND

Battery separators are microporous membranes that, among other roles, form physical barriers positioned between the cathode and anode of a battery to prevent the electrodes from physically contacting and causing, for instance, a short circuit. In Lithium-ion batteries, such as 3C batteries, electric drive vehicle (EDV) batteries, energy storage system (ESS) batteries, during operation, electrodes of the battery cell swell and contract based in part on heat generation, which can in turn affect a battery cell's performance due to an applied internal pressure or cause an explosion or fire. Further, as a battery's energy density increases, battery cell performance and safety become more of an issue due to higher heat generation and thermal propagation in the event of a short.

Consequently, there is a need for improved separators, membranes, and/or thin films that can be incorporated into battery cell systems to impart higher performance characteristics, such as higher energy density, and improved safety features over conventional battery separators.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are directed towards increasing battery or cell energy density, and more particularly in Li and Na batteries or cells. Further, embodiments of the technology described herein are directed towards reducing and/or stopping thermal propagation in a battery cell, for example through heat absorption.

According to some embodiments, a battery separator is provided comprising a microporous membrane comprising one or more layers of polyolefin and a heat absorption layer affixed to a surface of the microporous membrane, wherein the heat absorption layer is configured to reduce thermal propagation within a battery cell. The heat absorption layer can comprise a phase change material or a high heat capacity material configured to absorb heat in or above a normal battery cell operating temperature range. In some instances, the heat absorption layer is configured to reduce and/or stop thermal propagation within a battery cell. In some other instances, the heat absorption layer is configured to increase the energy density of a battery cell.

According to some further embodiments, a battery cell is provided comprising an anode, a cathode, and a separator disposed between the anode and the cathode. In some instances, the separator comprises a microporous membrane comprising one or more layers of polyolefin and a heat absorption layer affixed to a surface of the microporous membrane, wherein the heat absorption layer is configured to reduce thermal propagation within a battery cell. The heat absorption layer can comprise a phase change material or a high heat capacity material configured to absorb heat in or above a normal battery cell operating temperature range. In some instances, the heat absorption layer is configured to reduce and/or stop thermal propagation within a battery cell. In some other instances, the heat absorption layer is configured to increase the energy density of a battery cell.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, wherein:

FIG. 1 shows example configurations of a battery separator structure for reducing thermal propagation and/or absorbing heat in a battery cell, in accordance with some aspects of the technology described herein;

FIG. 2 is a schematic illustrating the reduction of thermal propagation and/or the absorption of heat in a battery cell provided by a battery separator, in accordance with some aspects of the technology described herein; and

FIG. 3 is a schematic illustrating energy densities among battery systems comparative to a battery cell incorporating a heat absorption battery separator, in accordance with some aspects of the technology described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

Separators or microporous membranes (also referred to herein as a battery separator or heat absorption separators) are incorporated into batteries or cells to perform a variety of functions, for example to prevent electronic contact between positive and negative electrodes of a battery and enabling ionic transport between electrodes, acting as a thermal fuse as a shutdown feature, amongst others.

Specific energy and/or energy density of batteries or cells relate to characteristics of a battery or cell (for example chemistry, packaging, and/or size) that, in part, determine battery energy and electric range. With improvements in battery components and chemistry, higher energy batteries or cells (for example Li, Li-ion, Na-ion) can be made which enable higher energy output and electric range. Accordingly, high energy batteries, cells, and battery systems, can have higher operating temperatures, and additionally, in the event of a short, thermal propagation through the battery cell or system at or above the operating temperature can cause operational and safety issues, such as overheating, explosion, or fire.

It will be appreciated that conventional Li and Na based batteries or cells can be limited in their design and capabilities due to a lack of incorporated components/materials, systems, and/or methodologies which can be configured to handle the functionality, capabilities, and/or safety problems associated with higher energy density batteries or cells.

According to embodiments of the present technology, separators (also used herein interchangeably with porous/microporous membranes, and films/thin films) can be implemented in a battery or battery system, and configured to mitigate, reduce, and/or otherwise stop thermal propagation within the battery or battery system. In some other embodiments, separators, or high heat separators, described herein can enable higher energy density in a battery or battery system, for example being configured to enable an energy density of greater than 350 Wh/kg and/or greater than 650 Ah/l.

According to some embodiments, separators or membrane systems for improved high energy density batteries are provided that incorporate a microporous membrane and a heat absorption layer. In some instances, the heat absorption layer comprises a heat absorption material. In some further instances, the heat absorption material can be a high heat capacity material. In some even further instances, the heat absorption material can be a phase change material. According to aspects described herein, the heat absorption material can be configured to absorb heat in or above a normal battery cell operating temperature range. Additionally, one or more heat absorption layers can be a part of or incorporated into a separator and/or membrane system that includes one or more polymer membranes and/or ceramic coatings.

In some embodiments, a separator (or battery separator or heat absorption separator), comprises a microporous membrane (e.g. a polymer membrane) and one or more heat absorption layers comprising a heat absorption material. According to various embodiments, a heat absorption layer can comprise a heat absorption material and another material, for example one or more polyolefins, binder materials and/or additives.

A microporous membrane as described herein can comprise one or more layers of a polyolefin, a fluorocarbon, a polyamide, a polyester, a polyacetal (or a polyoxymethylene), a polysulfide, a polyvinyl alcohol, a polyvinylidene, co-polymers thereof, or combinations thereof. In some embodiments, a microporous membrane described herein comprises one or more layers of a polyolefin (PO) such as a polypropylene (PP) or a polyethylene (PE), a blend of polyolefins, one or more co-polymers of a polyolefin, or a combination of any of the foregoing. It will be appreciated that a polyolefin as used in accordance with the present technology can be of any molecular weight not inconsistent with the characteristics of the microporous membranes or separators described herein.

A microporous membrane can in some instances comprise a semi-crystalline polymer, such as polymers having a crystallinity in the range of 20 to 100%. In some other embodiments, a microporous membrane or separator described herein can have a structure of a single layer, a bi-layer, a tri-layer, or multilayers. For example, a tri-layer or multilayer membrane can comprise two outer layers and one or more inner layers. In some instances, a microporous membrane can comprise 1, 2, 3, 4, 5, or more inner layers. In some other instances, each of the layers can be coextruded and/or laminated together. In some embodiments, a microporous membrane or separator as described herein can have any single layer, bi-layer, tri-layer, or multi-layer construction of PP and/or PE.

A microporous membrane described herein can additionally comprise fillers, elastomers, wetting agents, lubricants, flame retardants, nucleating agents, and other additional elements and/or additives not inconsistent with the objectives of this disclosure.

In some instances, the heat absorption material can comprise a phase change material, such as a wax, organic or inorganic materials or mixtures thereof capable of or configured to absorb heat in or above a normal battery operating temperature range. For example, the phase change material can be a polyethylene (PE) wax. In some other instances, the heat absorption material can comprise a high heat capacity (Cₚ) material, such as organic or inorganic materials, metals, metal salts, or mixtures thereof, capable of or configured to absorb heat in or above a normal battery operating temperature range. In some embodiments, the heat capacity (C_{P}) of the high heat capacity material can be from about 100 J/kg K to about 5000 J/kg K, for example the heat capacity (C_{P}) of the high heat capacity material can be from about 2500 J/kg K to about 4000 J/kg K.

In some embodiments, the heat absorption layer can comprise a heat absorption material and a binder material and/or other additive. In some other instances, the heat absorption layer can further comprise a polyolefin. In some further embodiments, the heat absorption layer can comprise the heat absorption material and a heat dissipation material, for example a heat dissipation material can comprise aluminum nitride (AlN), boron nitride (BN), or a mixture thereof. It will be appreciated that when a heat absorption and dissipation layer comprise both a high heat absorption material and a heat dissipation material, the high heat absorption material absorbs heat or otherwise melts or undergoes a phase change and the heat dissipation material will conduct heat away from the separator or separator system at a given rate. In some example embodiments, the heat dissipation material can have a thermal conductive range from about 0.01 W/m K to about 2200 W/m K, more specifically from about 100 W/m K to about 1000 W/m K.

According to some aspects, the heat absorption layer comprises at least 2% of the high heat capacity material, for example at least 5% of the high heat capacity material, for example at least 10% of the high heat capacity material. According to some other aspects the heat absorption material is present in the overall separator system in an amount of at least 2%. In some example embodiments, the high heat capacity material can be present in an amount from 2%-5%, from 2%-10%, from 2%-20%, from 2%-30%, from 2%-40%, from 2%-50%. In some other embodiments, the high heat capacity material is present in amount up to 50%, up to 60%, up to 70%, up to 80%, up to 90%, up to 100%.

The heat absorption layer can be positioned one or more surfaces of the polymer membrane, that is the heat absorption layer can be positioned on a first planar surface of the polymer membrane and/or on a second planar surface of the polymer membrane. In some instances, the heat absorption layer can be positioned between layers of the polymer membrane.

In some embodiments, a separator can additionally comprise one or more ceramic or ceramic-based layers and/or coatings. Accordingly, a separator can comprise a polymer membrane (i.e. one or more layers of a polyolefin), one or more heat absorption layer, and one or more ceramic or ceramic-based layers and/or coatings. In some instances, a heat absorption layer can be positioned on one surface (e.g. a first surface) of the polymer membrane and a ceramic layer can be positioned on the other surface (e.g. a second surface) of the polymer membrane. In some further instances, a heat absorption layer and a ceramic layer can be positioned between two polymer membrane layers. In some even further instances, a heat absorption layer and a ceramic layer can both be positioned on one of the surfaces (i.e. a first surface or a second surface) of a polymer membrane. In some even further instances, the heat absorption layer and the ceramic layer can be combined into a single layer or a combined layer. The combined layer can be positioned one or more surfaces of a polymer membrane or between polymer membranes.

It is contemplated that the heat absorption layer, the ceramic layer, and/or the combined layer can be coated, extruded, laminated, sandwiched on, or otherwise affixed to one or more substrate materials, for example a polymer membrane. Additionally, it is contemplated that any known binders and/or glues can be utilized in any of the layers, for instance as a component of the heat absorption layer and/or the ceramic layer.

In some embodiments, a heat absorption separator as described herein can be incorporated into a battery or cell. A battery cell can include, amongst other components, an anode, a cathode, and a separator disposed between the anode and cathode. The separator disposed between the anode and cathode can be a heat absorption separator as described herein.

In some instances, for example during operation or in the event of a short, the heat absorption separator can reduce thermal propagation within the battery or cell by at least 50%, by at least 60%, by at least 70%, by at least 80%, or by at least 90%. In some instances, the heat absorption separator can stop thermal propagation.

According to some aspects, the heat absorption separator can enable a battery or cell having improved volumetric energy density (Wh/l) and/or gravimetric energy density (Wh/kg). In some instances, for example, the heat absorption separator can enable a battery or cell having a volumetric energy density of greater than 300 Wh/l, greater than 400 Wh/l, greater than 500 Wh/l, or greater than 600 Wh/l. In some instances, for example, the heat absorption separator can enable a battery or cell having a gravimetric energy density of greater than 300 Wh/kg, greater than 400 Wh/kg, or greater than 500 Wh/kg.

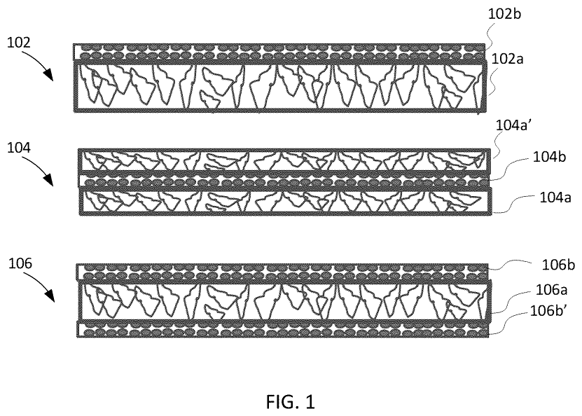

Referring now to the figures, FIG. 1 depicts example configurations of a battery separator structure 102, 104, 106 (e.g. a heat absorption separator) with which some embodiments of the present disclosure can be employed for reducing thermal propagation and/or absorbing heat in a battery cell, in accordance with some aspects of the technology described herein. It should be understood that this and other arrangements described herein are set forth as only examples. Other arrangements and elements can be used in addition to, or instead of, those shown, and some elements may be omitted altogether for the sake of clarity.

Among components shown, battery separator 102 includes microporous membrane 102a and heat absorption layer 102b affixed to one surface of microporous membrane 102a. Battery separator 104 includes microporous membranes 104a and 104a′ and heat absorption layer 104b. Battery separator 106 includes microporous membrane 106a, and heat absorption layers 106b and 106b′. In some embodiments, one of the heat absorption layers 106b, 106b′ can be replaced with a ceramic or ceramic-based layer. In some further embodiments, any of layers 102b, 104b, 106b, and 106b′ can be a composite layer comprising a heat absorption material and a ceramic material.

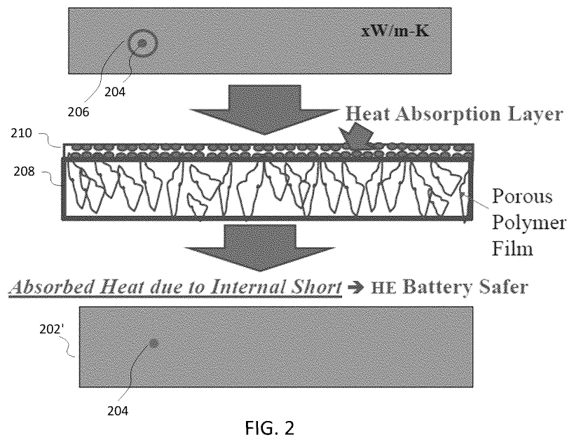

Turning now to FIG. 2, a schematic illustrating the reduction of thermal propagation and/or the absorption of heat in a battery cell provided by an implemented heat absorption battery separator according to some embodiments described herein is shown. Battery cell 202 is provided having an internal short 204 which causes heat generation and propagation within the battery cell 202. A battery separator (e.g. a heat absorption separator) is implemented in the battery cell having a microporous membrane 208 and a heat absorption layer 210. With the implementation of the battery separator in accordance with embodiments described herein, battery cell 202′ is provided having an internal short 204′ where any heat propagation or transfer of heat energy is reduced and/or stopped.

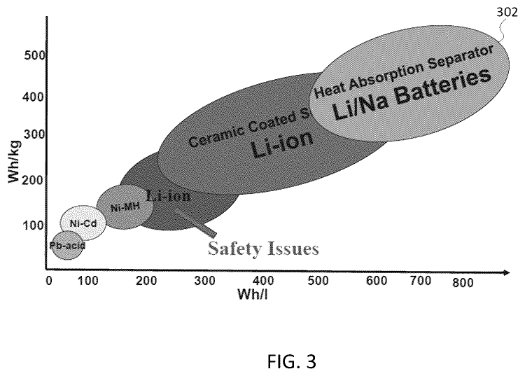

Looking at FIG. 3, a schematic illustrating energy densities among battery systems comparative to a battery cell incorporating a battery separator, in accordance with some aspects of the technology described herein is shown. As can be seen battery cell 302 incorporating a heat absorption separator comprising a microporous membrane and a heat absorption layer comprising a heat absorption material provides greater energy density capabilities to the battery system.

According to some further embodiments, a method of reducing and/or stopping thermal propagation in a battery cell is provided, for example thermal propagation due to normal operating temperatures of a high energy density battery or due to an internal short within a battery cell. According to some example embodiments, methods include providing separator comprising a microporous membrane, for example a microporous membrane comprising one or more layers of a polyolefin. A microporous membrane can have on one or more planar sides coated or layered with a layer comprising high heat capacity material and/or a phase change material. The high heat capacity material and/or phase change material can be coated otherwise affixed (e.g. extruded, laminated) to the microporous membrane. According to some embodiments, the microporous membrane is coated or layered with a heat absorption layer compromising at least 2% of a high heat capacity material or a phase change material. The separator comprising a high heat capacity and/or phase change material can be implemented in a battery cell and subjected to a heat range consistent with a high energy density battery. Once subjected to a heat range, the separator and/or the high heat capacity material layer can absorb heat by way of a heat capacity range from 100 J/kg K to 5000 J/kg K, more specifically from about 2500 J/kg K to about 4000 J/kg K.

In accordance with at least certain embodiments, aspects or objects of the invention, a battery separator is provided comprising at least one microporous membrane comprising one or more layers of a polyolefin or blend of polyolefins or a mixture of polyolefin and other materials, and at least one heat absorption layer affixed to at least one surface of the at least one microporous membrane, wherein the heat absorption layer is configured to absorb heat and reduce thermal propagation within a battery cell. The heat absorption layer can comprise at least one of a phase change material or a high heat capacity material configured to absorb heat in or above a normal battery cell operating range. The heat absorption layer can also comprise at least one heat dissipation material. The heat absorption layer may also be positioned between two microporous membranes.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1.-26. (canceled)

27. A battery separator comprising:
a microporous membrane comprising one or more layers of polyolefin; and
a heat absorption layer affixed to a surface of the microporous membrane, wherein the heat absorption layer comprising at least 2% of a high heat capacity material and is configured to reduce thermal propagation within a battery cell.

28. The battery separator of claim 27, wherein the high heat capacity material comprises a phase change material.

29. The battery separator of claim 28, wherein the high heat capacity material is an organic material, an inorganic material, or a mixture thereof configured to absorb heat in or above a normal battery cell operating temperature range.

30. The battery separator of claim 27, wherein the heat absorption layer comprising the high heat capacity material has a heat capacity from 100 J/kgK to 5000 J/kgK.

31. The battery separator of claim 30, wherein the heat absorption layer comprising the high heat capacity material has a heat capacity from 2500 J/kgK to 4000 J/kgK.

32. The battery separator of claim 27, wherein the heat absorption layer comprises a binder.

33. The battery separator of claim 27, further comprising a ceramic layer.

34. The battery separator of claim 27, wherein the heat absorption layer is configured to reduce thermal propagation within a battery cell by at least 50%.

35. The battery separator of claim 27, wherein the heat absorption layer is configured to increase the energy density of a battery cell.

36. The battery separator of claim 27, wherein the microporous membrane comprises one or more polyolefins.

37. The battery separator of claim 27, wherein the polyolefin is polyethylene, polypropylene, or a combination of both.

38. The battery separator of claim 27, wherein the microporous membrane is a single layer film, a bilayer film, a trilayer film, or a multilayer film.

39. The battery separator of claim 27, wherein the heat absorption layer comprises a heat dissipation material.

40. The battery separator of claim 28, wherein the phase change material is a polyethylene wax.

41. A battery cell comprising:
an anode;
a cathode; and
a separator disposed between the anode and the cathode, the separator comprising:
a microporous membrane comprising one or more layers of polyolefin; and
a heat absorption layer affixed to a surface of the microporous membrane, wherein the heat absorption layer comprises at least 2% of a high heat absorption material and is configured to reduce thermal propagation within a battery cell.

42. The battery cell of claim 41, wherein the heat absorption layer comprises a phase change material.

43. The battery cell of claim 42, wherein the phase change material is an organic material, an inorganic material, or a mixture thereof configured to absorb heat in or above a normal battery cell operating range.

44. The battery cell of claim 41, wherein the heat absorption layer comprises a high heat capacity material.

45. The battery cell of claim 44, wherein the high heat capacity material is an organic material, an inorganic material, a metal, a metal salt, or a mixture thereof configured to absorb heat in or above a normal battery cell operating range.

46. The battery cell of claim 41, wherein the heat absorption layer is configured to reduce thermal propagation within a battery cell by at least 50%.

47. The battery cell of claim 41, wherein the separator further comprises a ceramic layer.

48. The battery cell of claim 41, wherein the heat absorption layer is configured to increase the energy density of a battery cell.

49. The battery cell of claim 41, wherein the high heat absorption material has a heat capacity from 100 J/kgK to 5000 J/kgK.

50. The battery cell of claim 41, wherein the high heat absorption material has a heat capacity from 2500 J/kgK to 4000 J/kgK.

51. The battery cell of claim 41, wherein the heat absorption layer comprises a heat dissipation material.

52. The battery cell of claim 42, wherein the phase change material is a polyethylene wax.

53. A battery separator comprising at least one microporous membrane comprising one or more layers of a polyolefin or blend of polyolefins or a mixture of polyolefin and other materials, and at least one heat absorption layer affixed to at least one surface of the at least one microporous membrane, wherein the heat absorption layer is configured to absorb heat and reduce thermal propagation within a battery cell, the heat absorption layer may comprise at least one of a phase change material or a high heat capacity material configured to absorb heat in or above a normal battery cell operating range, the heat absorption layer may also comprise at least one heat dissipation material, and the heat absorption layer may also optionally be positioned between two microporous membranes.
